(19) United States
(12) Patent Application Publication
(10) Pub. No.: US 2016/0266298 A1
(43) Pub. Date: Sep. 15, 2016

(54) BACKLIGHT SYSTEMS CONTAINING DOWNCONVERSION FILM ELEMENTS

(71) Applicant: 3M INNOVATIVE PROPERTIES COMPANY, Saint Paul, MN (US)

(72) Inventors: Joshua D. TIBBITS, Eagan, MN (US); Shu-Ching FAN, Woodbury, MN (US); Fumihisa HANZAWA, Tokyo (JP); Tatsuya NAKAMURA, Tokyo (JP); Hideaki SHIROTORI, Kanagawa (JP); John F. VAN DERLOFSKE, III, Minneapolis, MN (US)

(21) Appl. No.: 15/033,169

(22) PCT Filed: Sep. 15, 2014
(86) PCT No.: PCT/US2014/055606

§ 371 Date: Apr. 29, 2016

Related U.S. Application Data
(60) Provisional application No. 61/898,087, filed on Oct. 31, 2013.

(51) Int. Cl. F21V 8/00; G02F 1/1335

(52) U.S. Cl. CPC G02B 6/005; G02B 6/0055; G02B 6/0088; G02F 1/133617

(57) ABSTRACT

Edge-lit LCD backlight units having a viewable area comprise (a) a downconversion film element, (b) a light guide comprising extraction elements, (c) a reflector and (d) blue LEDs. The extraction elements extend beyond the viewable area.

### FIELD

This invention relates to methods of improving color uniformity in backlight systems containing a downconversion film element and to the improved backlight systems.

### BACKGROUND

Liquid crystal displays (LCDs) are non-emissive displays that utilize a separate backlight unit and red, green and blue color filters for pixels to display a color image on a screen. The red, green and blue color filters respectively separate white light emitted from the backlight unit into red, green and blue lights. The range of colors that can be displayed by an LCD device is called color gamut.

LCD backlight systems typically include a film stack containing a reflector plate or film, a light guide (for example, a light guide plate or light guide film) containing extraction features, a diffusing sheet, light redirecting films (for example, prism films, lenticular films and/or other brightness enhancement films) and/or a reflective polarizer. Traditionally, LCDs have utilized white light-emitting diodes (LEDs) consisting of a blue LED die combined with a yellow YAG phosphor. Mobile/handheld devices are typically edge-lit and contain a light guide to uniformly distribute light over the display area. The “white” light is then diffused out of the light guide using a diffuser sheet. Recently, however, LCDs having improved color gamut been developed. In these LCDs, white LEDs are replaced with blue LEDs and the diffuser sheet is replaced with a downconversion film element that actively converts color. The downconversion sheet may comprise, for example, red and green quantum dots, phosphors, fluorescing dyes and the like. By simply replacing the bottom diffuser sheet in a typical LCD backlight with a quantum dot film element, the achieved color gamut can be increased dramatically (for example, by 50%).

One issue associated with backlight systems containing quantum dot film elements or other downconversion film elements is color non-uniformities near the boundaries of the backlight (that is, at the edges of the viewable area of the display). Typically, this non-uniformity manifests itself as a blue glow at the edge of the viewable area of the display. This glow is commonly thought to be the result of blue light leakage out of the edge of the backlight system.

### SUMMARY

In view of the foregoing, we recognize that there is a need for improved color uniformity in backlight systems containing downconversion film elements.

Surprisingly, we have discovered that color non-uniformity at the edge of the viewable area of displays containing downconversion film elements is not attributable to blue light leakage alone as previously believed. Rather, we have discovered that the color non-uniformity is primarily caused by insufficient red and green light at the edge of the display due to the difference in the angular distribution of red and green light versus blue light.

Briefly, in one aspect, the invention provides edge-lit LCD backlight units having a viewable area comprising (a) a downconversion film element, (b) a light guide comprising extraction elements (c) a reflector and (d) blue LEDs; wherein the extraction elements extend beyond the viewable area.

In another aspect, the invention provides LCD backlight units comprising (a) a support structure, (b) a downconversion film element, (c) a reflector, (d) blue LEDs and (e) at least one of a highly reflective material and a down converting material; wherein the highly reflective material or the down converting material overlaps the edges of the downconversion film element or is applied to the support structure.

In yet another aspect, the invention provides edge-lit LCD backlight units having a viewable area comprising (a) a support structure, (b) a downconversion film element, (c) a light guide comprising extraction elements, (d) a reflector, (e) blue LEDs and (f) at least one of highly reflective material and a down converting material; wherein the highly reflective material or the down converting material overlaps the edges of the downconversion film element or is applied to the support structure, and wherein the extraction elements extend beyond the viewable area.

In still another aspect, the invention provides methods of improving color uniformity across an LCD backlight unit having a viewable area. The method comprises increasing red and green light in at least one edge of the viewable area; wherein the LCD backlight unit comprises a downconversion film element, a reflector and blue LEDs.

### BRIEF DESCRIPTION OF THE DRAWINGS

The invention may be more completely understood in consideration of the following detailed description in connection with the following figures:

FIG. 1 is a diagram of a top view of a light guide and extraction patterned areas.

FIG. 2 is a diagram of a measurement set up utilized in the Examples.

FIG. 3a is a camera image from the set up shown in FIG. 2.

FIG. 3b is measurement data from the set up shown in FIG. 2.

FIG. 4 is measurement data from the set up shown in FIG. 2.

FIG. 5a is a diagram of a top view of a light guide and extraction pattern.

FIG. 5b is a camera image of a region shown in FIG. 5a.

FIG. 6a is a top view of a light guide and extraction pattern.

FIG. 6b is a camera image of a region shown in FIG. 6a.

FIG. 7 is measurement data corresponding to FIGS. 5b and. 6b.

FIG. 8 is measurement data corresponding to FIGS. 5b and 6b.

FIG. 9 is measurement data corresponding to FIG. 6b.

FIG. 10 is a diagram of a measurement set up utilized in the Examples.

FIG. 11a is a pair of camera images based on the set up of FIG. 10.

FIG. 11b is measurement data corresponding to FIG. 11a.

FIG. 12 is a diagram of a measurement set up utilized in the Examples.

FIG. 13a is a pair of camera images based on the set up of FIG. 12.

FIG. 13b is measurement data corresponding to FIG. 13a.

FIG. 14a is another set of camera images based on the set up of FIG. 12.

FIG. 14b is measurement data corresponding to FIG. 14a.

FIG. 15 is a diagram of a measurement set up utilized in the Examples.

FIG. 16a is a pair of camera images based on the set up of FIG. 15.

FIG. 16b is measurement data corresponding to FIG. 16a.

FIG. 17 is a diagram of a measurement set up utilized in the Examples.

FIG. 18a is a pair of camera images based on the set up of FIG. 17.

FIG. 18b is measurement data corresponding to FIG. 18a.

FIG. 19 is a diagram of a measurement set up utilized in the Examples.

FIG. 20a is a pair of camera images based on the set up of FIG. 19.

FIG. 20b is measurement data corresponding to FIG. 20a.

### DETAILED DESCRIPTION

In order to achieve a uniform white color across a display, a uniform mixture of red, green and blue needs to be maintained spatially. We have recognized that in backlights containing downconversion sheets such as quantum dot films, the mixture of red, green and blue is not spatially uniform primarily because the different colors of light come from different sources. The red and green light, for example, comes from the quantum dots. Photons are emitted by the quantum dots in all directions equally. The red and green light thus has a wide angular distribution. Blue light, on the other hand, comes from the blue LEDs. The blue light is not is not distributed in all directions equally. The angular distribution of the blue light is largely determined by the optical film stack (for example, the light guide, diffuser and/or light redirecting films, etc.) in the backlight system. The blue light thus typically has less spread as compared to red and green light.

A result of the wide angular distribution of the red and green light is that the color at any one point is not only determined by the light coming from the area directly under that point, but also by the light coming from adjacent areas. Red and green light is thus more dependent on the light emitted by adjacent areas than the blue light because of its wider angular distribution.

In edge-lit LCD backlight systems, a light guide with extraction features is typically used to provide more uniform light to the display. The extraction features typically vary in density over the viewable display area to achieve a uniform appearance. For example, there are typically few extraction features near the LEDs and an increasing density of extraction features as you move away from the LEDs. It is common practice to end the extraction features close to the edge of the viewable area of the LCD panel. We have discovered that in edge-lit backlight systems containing downconversion film elements (for example, quantum dot films), ending the extraction features at the edge of the viewable area results in more blue color at the edge of the viewable area because there is not enough red and green light available at the edge to mix with the blue light and produce white light. That is, very little red and green light is being generated outside the area containing the extraction features.

Furthermore, we have recognized that the red and green light that is emitted from the quantum dot film at the edge of display is not sufficient to produce uniform color because more red and green light is lost out the edge of the display than blue light due to the difference in angular distribution.

To improve color uniformity near the edge of the display area, we have discovered that it is necessary to make-up for the “missing” red and green light at the display edge. This can be accomplished using various methods. One method is to move all boundary conditions away from the viewable edge of the display. It is not enough to merely extend the downconversion film element and light guide outside the viewable region. For this method, any recycling films should be extended out past the viewable region in order to maintain uniform light recycling at the viewable edge. In addition, any extraction features on the light guide must also continue out past the viewable region to increase blue light extraction. Uniform light recycling is not sufficient on its own. In some embodiments, the extractions features may be graded to provide uniform extraction efficiency across the light guide.

One tradeoff with the above approach is that the LCD bezel (that is, the frame that encloses the display screen and covers the non-viewable region of the screen) may need to be larger than is typically desirable in some applications. Another tradeoff is that there may be a drop in display efficiency due to the wasted light outside of the viewable region.

Another method to improve color uniformity near the edge of the display area, which works in both edge-lit and direct-lit LCD backlight systems, is to reflect back the red and green light that is lost out the edge of the display. One way to do this is to add a highly reflective material such as a highly reflective coating, paint, ink, film or tape (for example, rim tape) and/or down converting material to the edges of the downconversion film element below the light redirecting films or to the edges of the light guide. The highly reflective material and/or down converting material can be applied at the top, the sides, a combination of the top and sides or all around the edges of the downconversion film element or the light guide. For example, white ink can be printed around or white tape can be adhered around the edges of the downconversion film element. Alternatively, or in addition, a highly reflective material and/or down converting material can be applied to the backlight mechanical support structure (for example, the frame).

Suitable reflective materials include both specular and diffuse reflectors and may be at least about 70% reflective, 80% reflective, 90% reflective or nearly 100% reflective. White tapes or paints can be suitable highly reflective materials. One specific useful highly reflective material is ESR (Enhanced Specular Reflector available from 3M Co.), which is nearly 100% reflective. Less reflective materials can be utilized, but they may need to overlap the downconversion film element to a greater extent. The amount of overlap of the highly reflective material on the downconversion film element that is necessary will vary with the reflectivity of the material. In general, the more reflective the material, the less overlap required. In some embodiments the material may overlap a quantum dot film, for example, by about 0.5 mm to about 2 mm. One of skill in the art will appreciate how use the reflectivity and the overlap to fine tune the output color from the display near the edges.

Suitable down converting materials can include red and green quantum dots, phosphors, fluorescing dyes or the like. The down converting material can be the same material as the downconversion film element.

In some edge-lit displays, it can be preferable to combine both approaches described above, particularly when minimizing bezel width and maximizing display efficiency is of concern. A proper balance of red, green and blue light can be achieved by adjusting the amount of blue light extraction, the reflectivity and the overlap distance on the downconversion film element.

### EXAMPLES

Objects and advantages of this invention are further illustrated by the following examples, but the particular materials and amounts thereof recited in these examples, as well as other conditions and details, should not be construed to unduly limit this invention.

### Approach 1

It has been discovered that large variations in extracted light over small spatial dimensions can cause a color shift in the light coming out of the backlight. Using a Prometric camera (Radiant Imaging PM Series Imaging Colorimeter PM-9913E-1) to measure spatial color and luminance of a device, we gathered data to demonstrate this effect and also show improvements.

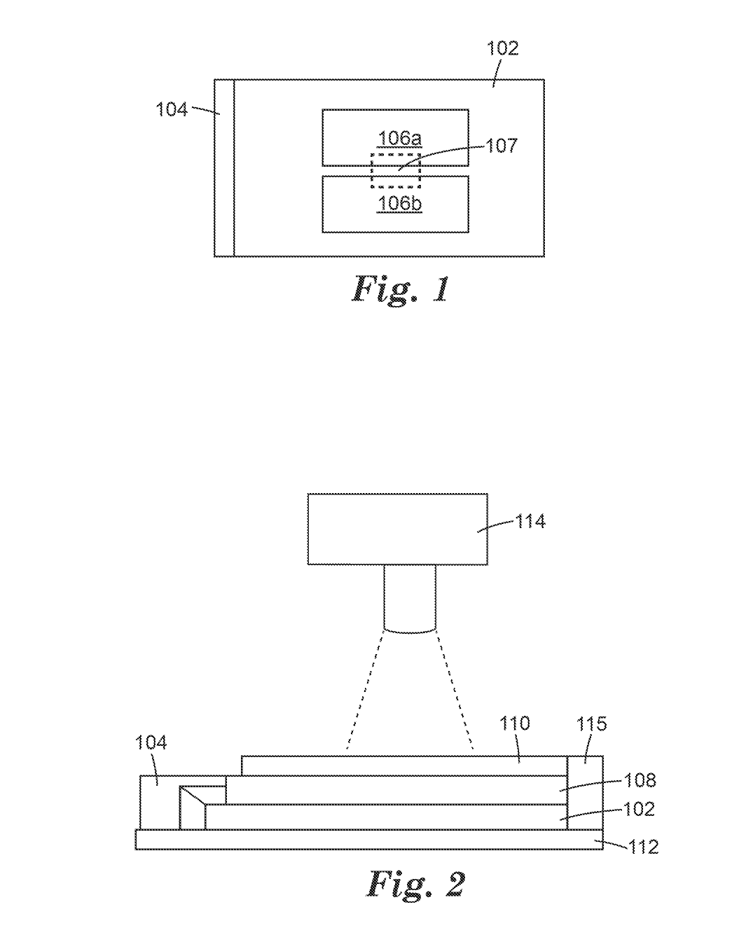

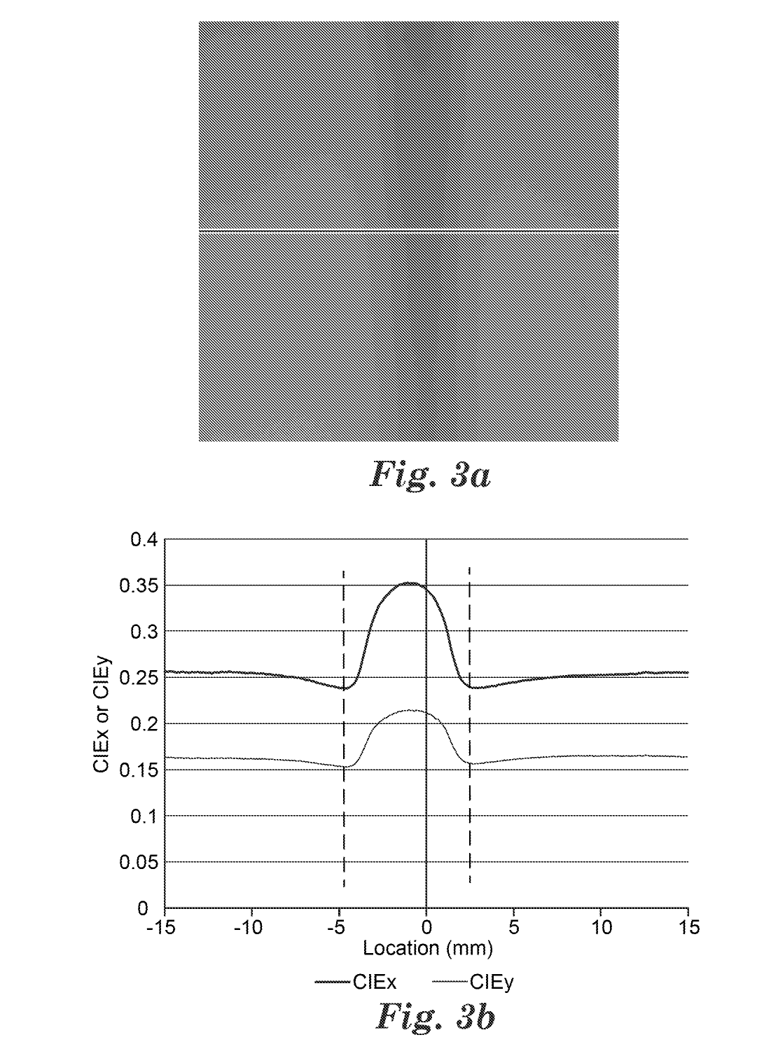

To demonstrate this effect, as shown in FIG. 1, a light guide 102 was lit by blue LEDs 104 and placed on a large sheet of ESR (112, not visible in FIG. 1). This light guide 102 had two separate rectangular areas with extraction patterns 106a, 106b as well as areas within the guide that had no extraction features. This light guide 102 was used in the setup shown in FIG. 2. On top of the light guide 102 and ESR 112, 3M™ QDEF-210 (Quantum dot enhancement film from 3M Company) 108 and crossed prisms film (BEF4-GT and BEF-GMv5 available from 3M Company) 110 were placed. Mechanical support structure 115 formed a border of the film stack that included 102, 108 and 110. The Prometric camera 114 was positioned above the stacked films and focused on area 107. The output from this setup, shown in FIGS. 3a and 3b, shows a significant shift to the blue in the output color near the edge of the extraction features. FIG. 3a is an image from the camera. FIG. 3b contains cross section color data along the center line of FIG. 3a; the dashed vertical lines in FIG. 3b show approximate locations of the edges of the extraction patterns 106a and 106b. There were no extraction features in the region between the dashed lines.

FIG. 3b shows that the CIE x and y color coordinates decrease near the edges of the extraction patterns 106a and 106b in the film light guide 102. Visually, this is seen as a more blue area. The area between extraction regions shows an increase in x and y values, but this effect is not visible due to the low luminance in this region.

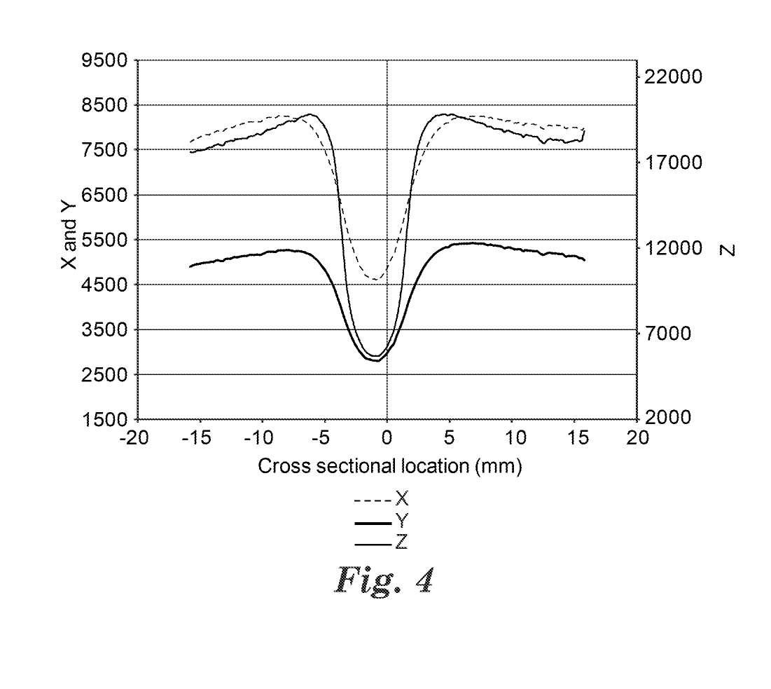

Another way to look at the above data is to use the tristimulus values instead of CIEx and CIEy. This allows separation of the blue light from the red and green light. FIG. 4 shows the same cross section as FIG. 3b, but instead of x and y, it shows X, Y and Z. This helps explain why the edges of extraction areas 106a and 106b are bluer than the centers of extraction areas 106a and 106b.

A Kindle Fire HDX was obtained from Amazon. The light guide plate from the Kindle Fire HDX was used to show that moving the extraction pattern 106 to the edge of the light guide plate improves the blue color on the edge of a display. The light guide plate was removed from the backlight. A rotary paper cutter was then used to cut ˜1 cm off the short edge of the light guide plate. This effectively moved the extraction dots to the edge of the light guide plate and also allowed imaging of the edge of the light guide plate without the frame nearby. The backlight was then reassembled and imaged with the Prometric camera at the location of the cut light guide edge. The light guide was then shifted laterally in the backlight so that the opposite, uncut edge could be imaged away from the frame and optical film edge.

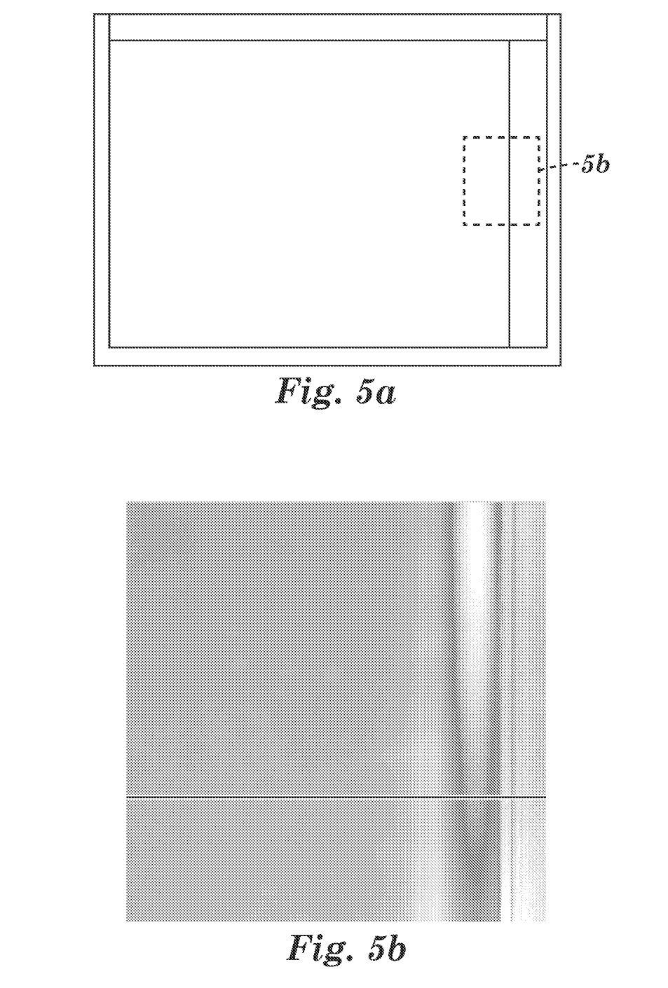

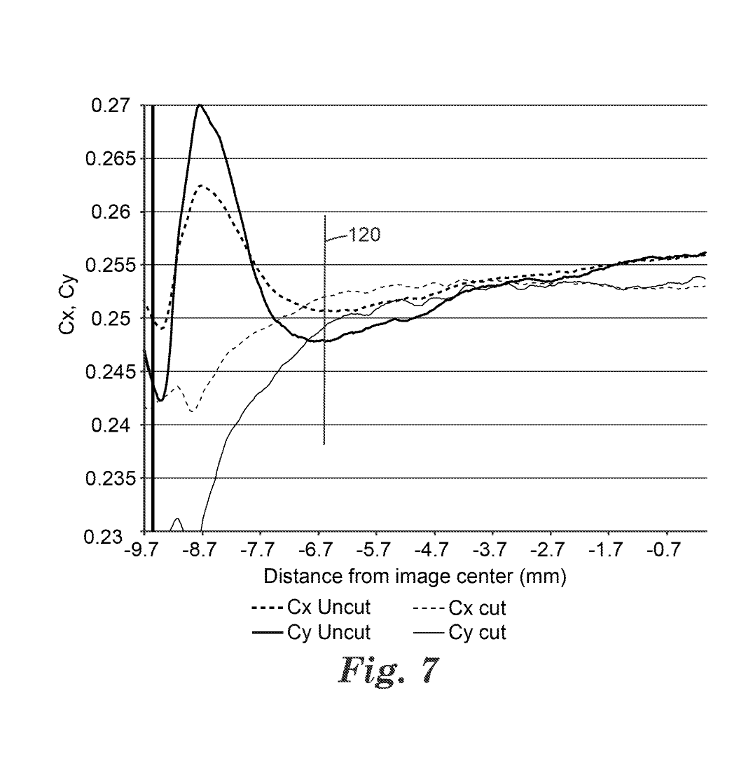

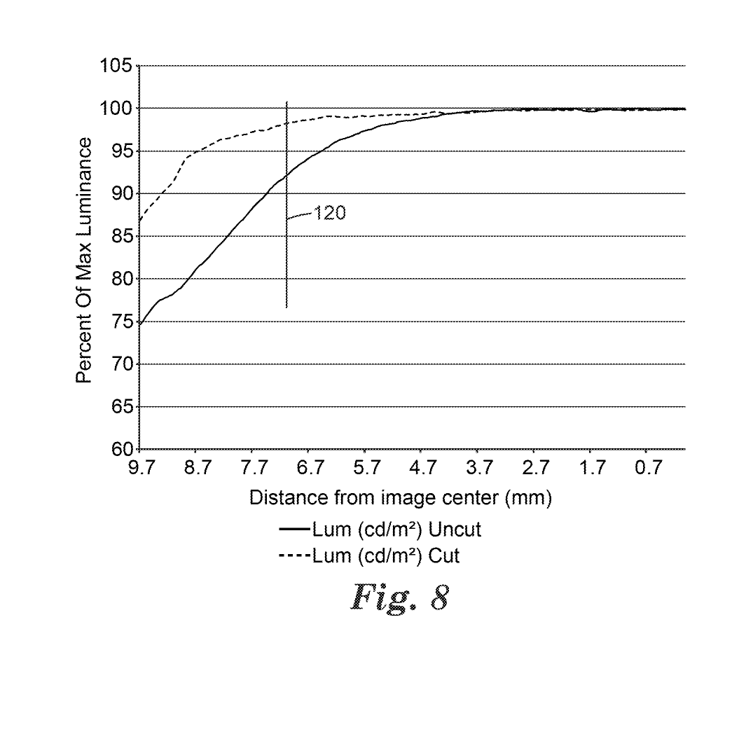

FIG. 5a shows the location where the Prometric data shown in FIGS. 7 and 8 was taken in the cut light guide case and FIG. 5b shows the Prometric image used to take the cross section data. (Data was taken here and in succeeding images along the center line of each image.)

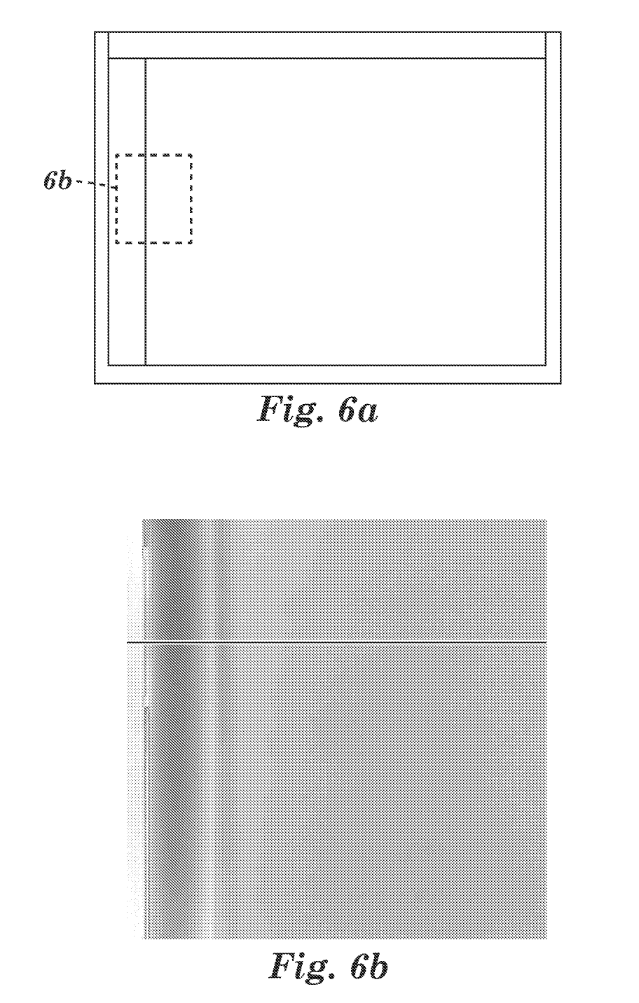

FIG. 6a shows the location where the Prometric data shown in FIGS. 7 and 8 was taken in the uncut light guide case and also the Prometric image used to take the cross section data.

The data in FIG. 7 shows the improvement in color (increased x and y) at the edge of the viewable area if the light guide plate edge is in the normal location. Line 120 in FIGS. 7, 8 and 9 identifies the left edge of the viewable area; all data to the right of 120 come from the viewable area.

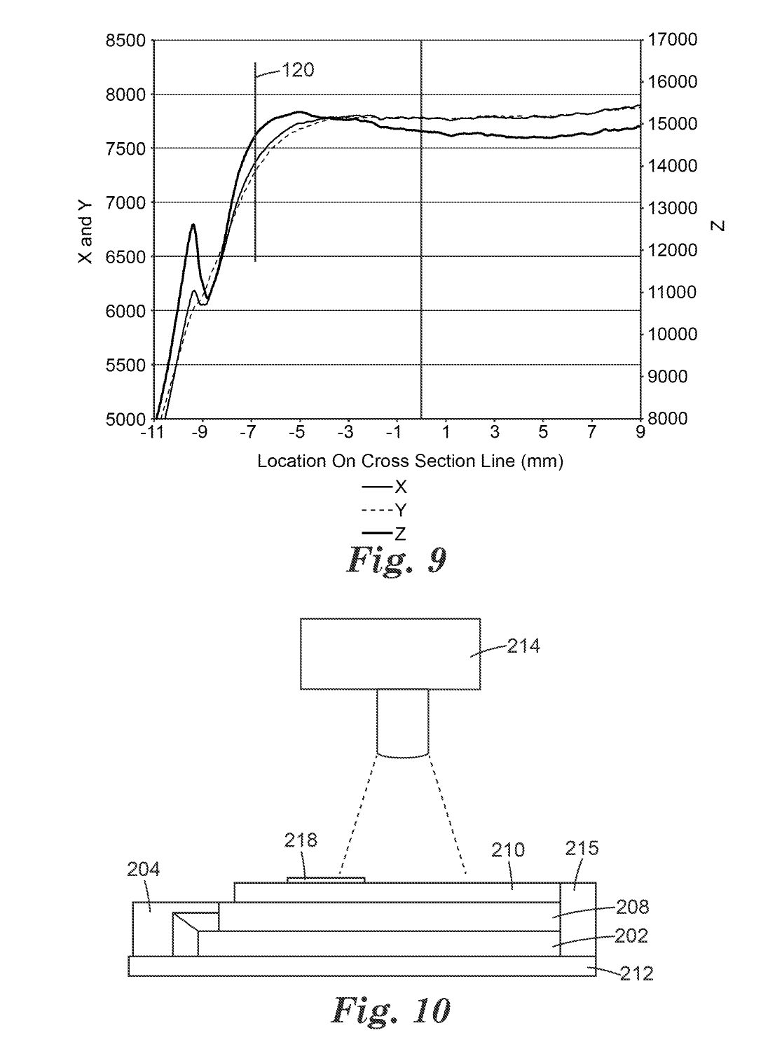

It is useful to look at the data from the cross section view in tristimulus values to separate the three main colors. FIG. 9 shows the tristimulus values along the cross section in FIG. 6b of the uncut light guide plate. This shows that the red and green color is more spread laterally than the blue.

If we were to repeat this study with a light guide plate manufactured with extraction dots past the viewable area, we expect that the results would be further improved. In the case of this experiment, the cut edge of the plate was not as straight or smooth as a manufactured plate would be so there was extra blue light extracted from the edge of the plate that normally would not be present.

The above experiments have shown that the output light from the non-LED edge of the light guide plate can be improved by modifying the extraction pattern of the light guide plate to extend further into the non-viewable region of the backlight.

### Approach 2

It has been discovered that the color uniformity on the edge of the viewable area of a LCD display containing QDEF can be improved by adding rim tape directly to the QDEF part (below the prism films). Controlling the edge color with rim tape requires control of the rim tape reflectivity as well as the rim tape overlap distance on the QDEF part.

This example shows that a white tape (72% R, 4562H-50 from 3M Company) is better than a black tape and putting tape on QDEF has much more effect on adjacent color than putting tape on top of prisms. These following experiments were done to look at the effect of tape reflectivity on the QDEF backlight system without involving any non-uniformity due to extraction changes. To accomplish this goal, the testing was done in the center of the light guide plate instead of the edge where rim tape would normally be placed.

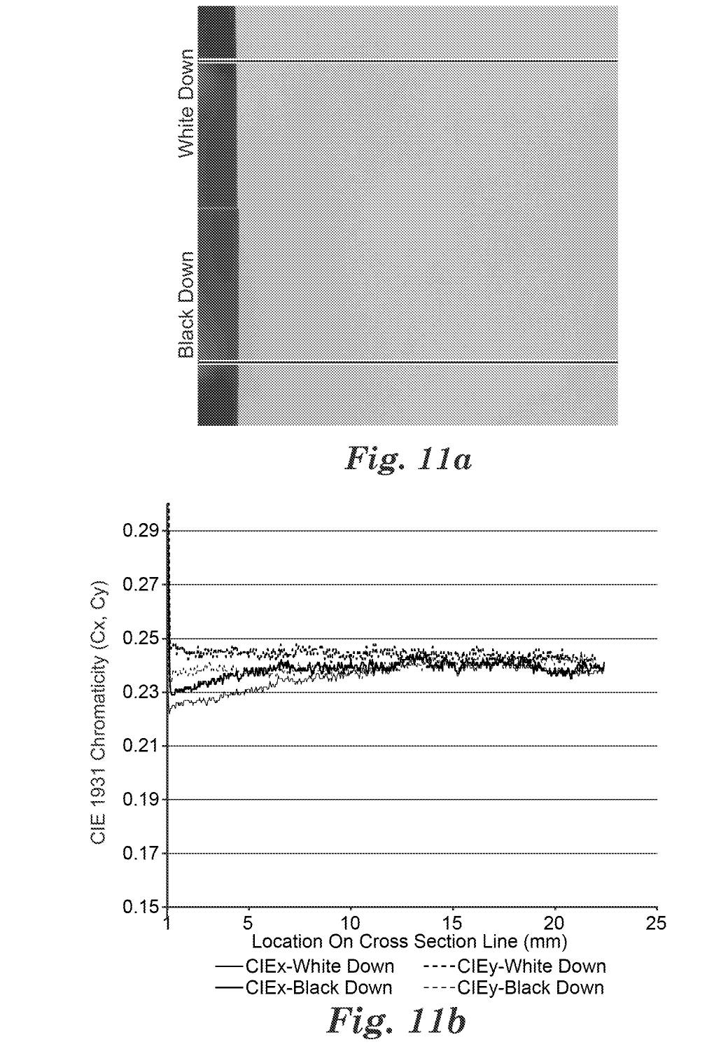

As shown in FIG. 10, a light guide plate from a Kindle Fire HDX 202 was lit by blue LEDs 204 and placed on a sheet of ESR 212. 3M™ QDEF-210 208 and crossed prism film 210 were placed on top of the light guide plate 202 and ESR 212. Tape 218 was applied to crossed prism film 210 as shown. Mechanical support structure 215 formed a border of the film stack that included 202, 208 and 210. A Prometric camera 214 was positioned above the stacked films and used to measure color and luminance over the area shown in FIG. 10.

The picture and graph shown in FIGS. 11a and 11b show that having white tape on the prisms has little effect on the color next to the tape, but with black tape, there is a region with lower CIEx and CIEy values next to the tape.

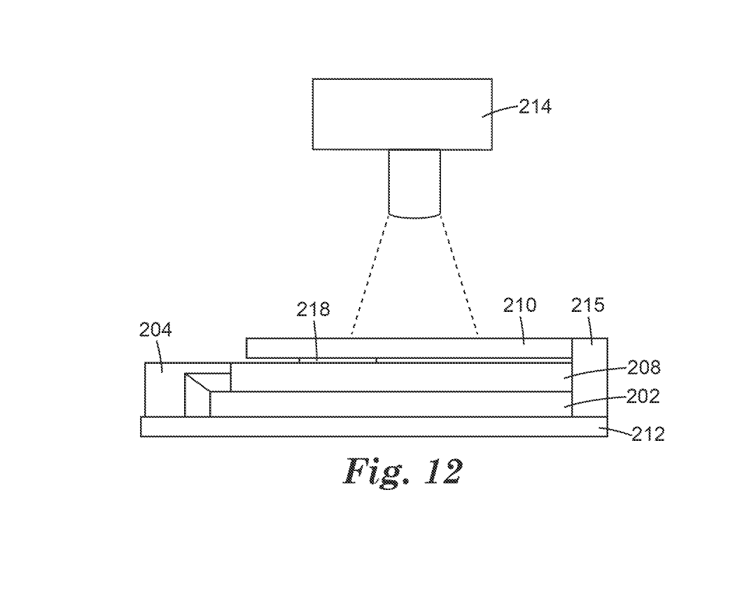

Next, the experiment above was repeated. This time the tape 218 was placed between the prisms and the QDEF as shown in FIG. 12. The result shows that there is a greater effect on the color next to the tape if the tape is applied directly to the QDEF instead of to the prisms.

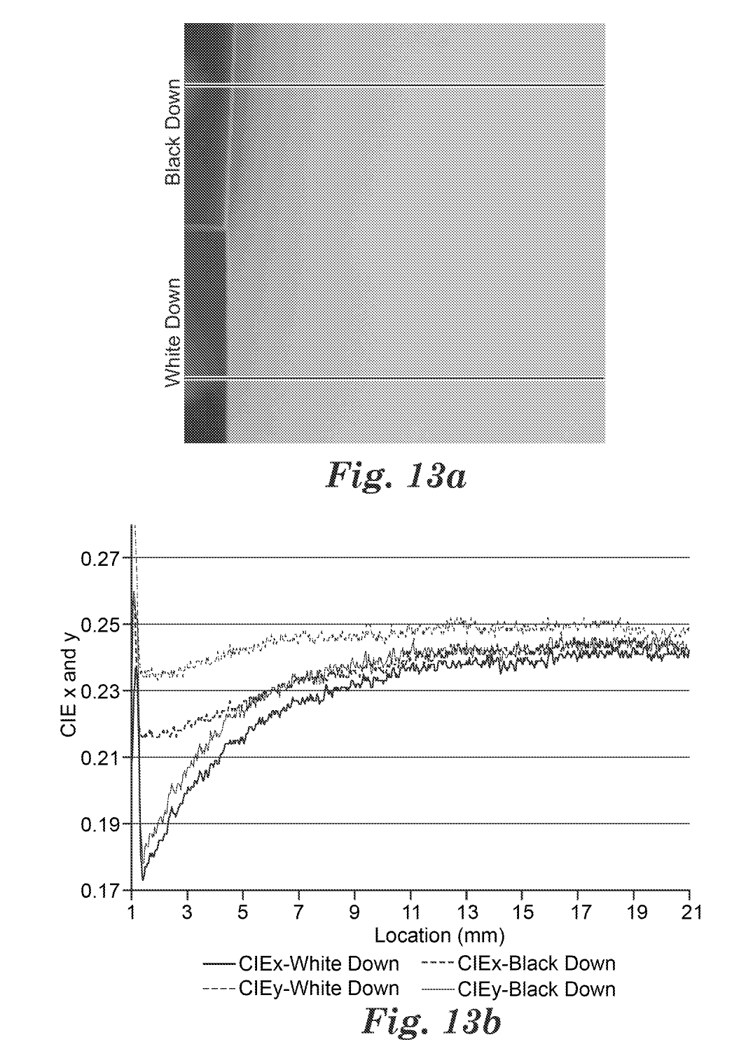

The picture and graph shown in FIGS. 13a and 13b show that having white tape on the QDEF causes a significant decrease in the CIEx and CIEy values next to the tape (more blue in color). For the black tape, the effect is even greater.

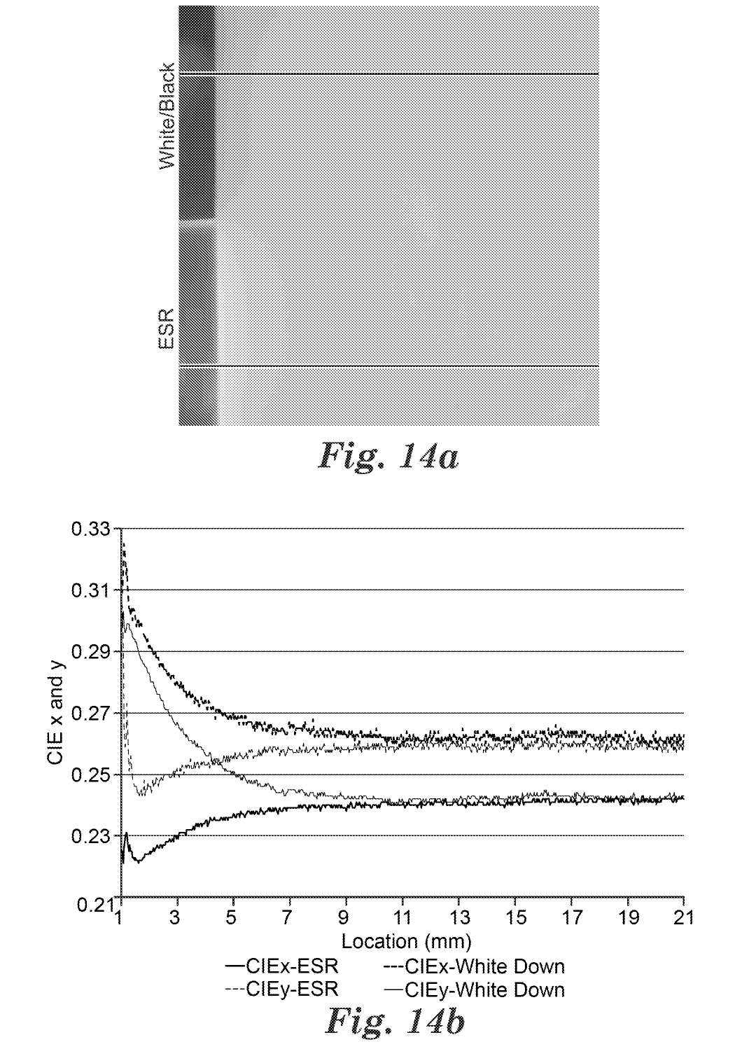

Next, white tape (72% R) was compared to ESR film (˜100% R). The previous experiment was repeated with this new comparison. The result as shown in FIGS. 14a and 14b shows that you can change the color of the output light next to the tape from blue to yellow by increasing the reflectivity of the tape. In the next case, the measurement diagram is the same as in FIG. 12, but ESR film was used in place of black tape.

The picture in FIG. 14a and graph in FIG. 14b show that having white tape on the QDEF causes a significant decrease in the CIEx and CIEy values next to the tape (more blue in color). ESR, however, causes a significant increase in the CIEx and CIEy values (more yellow in color).

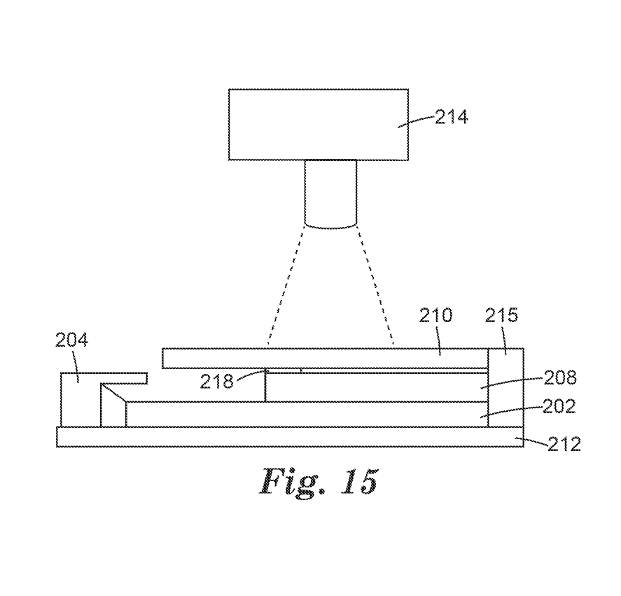

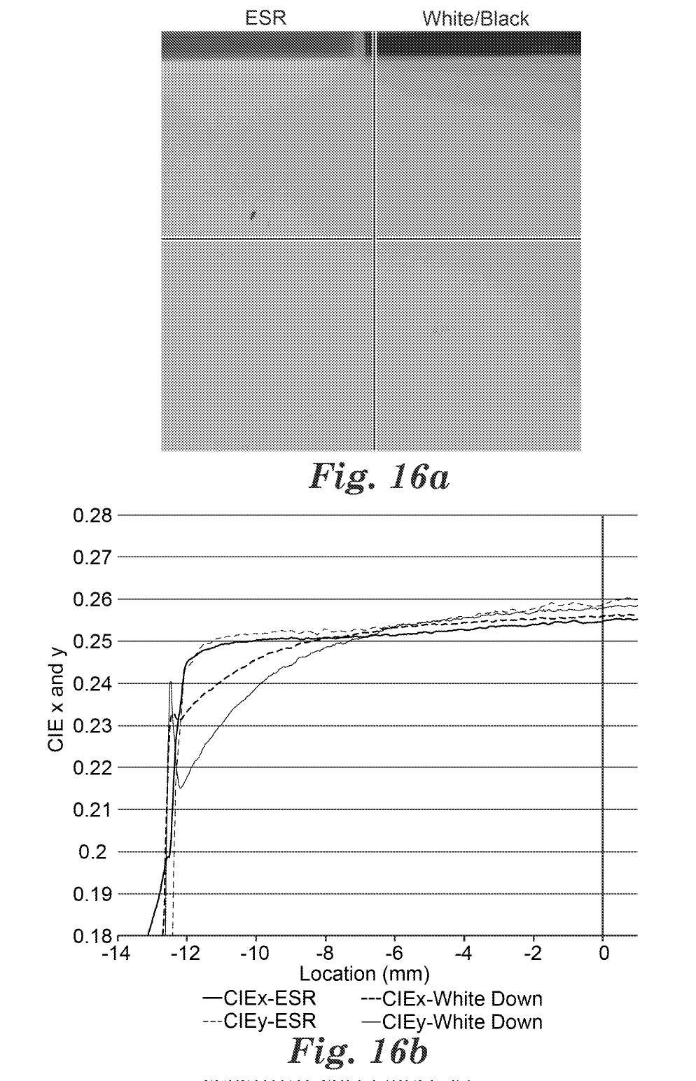

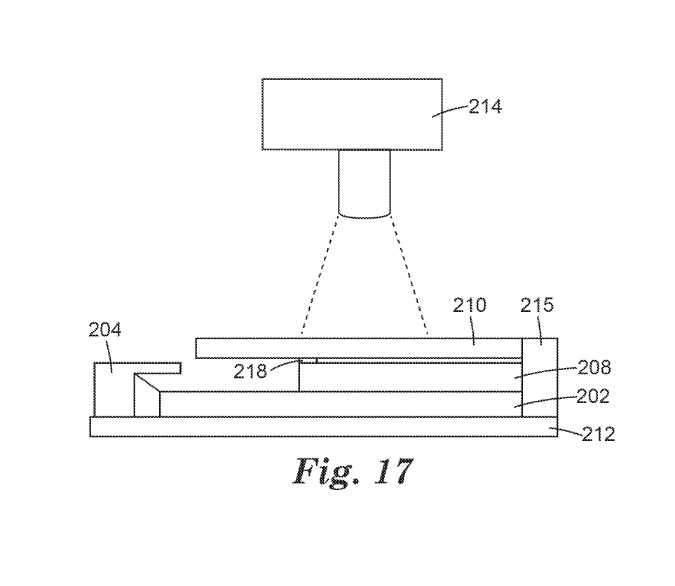

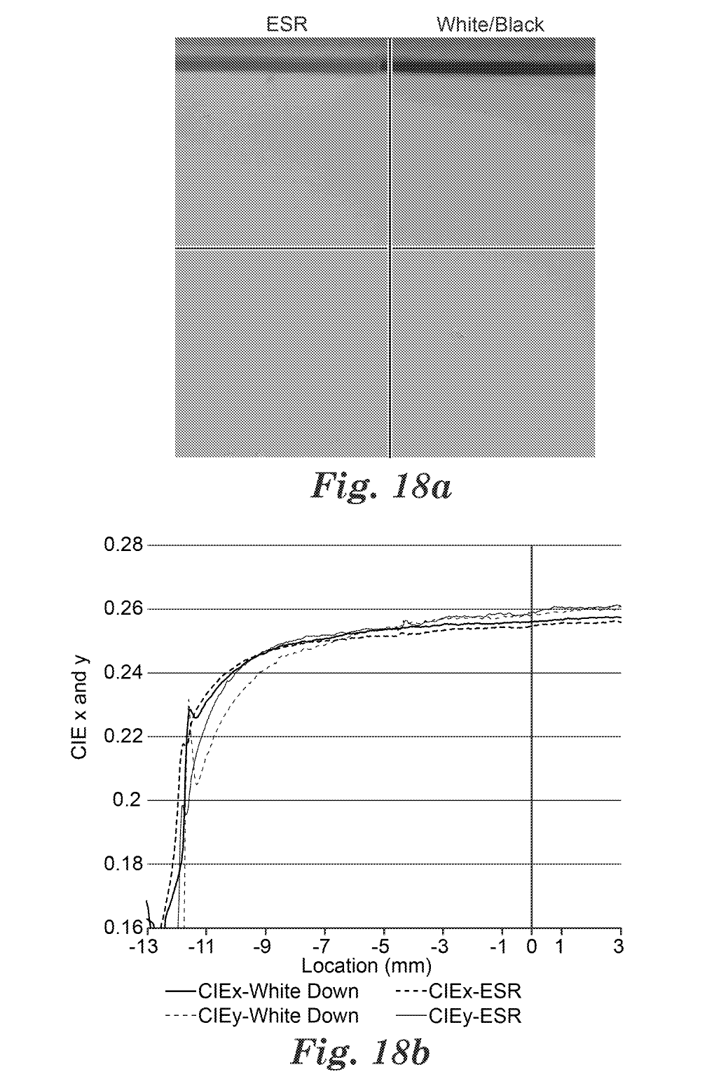

The following experiments show how these tapes affect the output color when they are used near the edge of the QDEF part, but still in the center of the light guide plate. A Prometric camera was positioned above the stacked films as shown in FIG. 15 and used to measure color and luminance with the tape overlapped 2 mm. This was repeated with the tape overlapped 1 mm as shown in FIG. 17. The results shown in FIGS. 16a, 16b, 18a and 18b show that the overlap area has a large effect on the color next to the tape. The picture in FIG. 16a and graph in FIG. 16b show that having ESR overlapping the QDEF edge by 2 mm results in increased CIEx and CIEy values right next to the tape as compared to the white tape case. The picture and graph in FIGS. 18a and 18b show that having ESR overlapping the QDEF edge by 1 mm results in increased CIEx and CIEy values right next to the tape as compared to the white tape case but that the difference between the two tapes is smaller in this case than with 2 mm overlap.

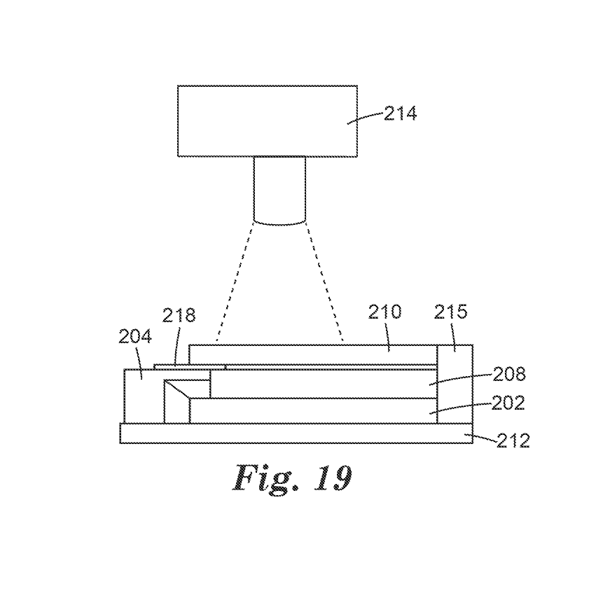

Lastly, an experiment was conducted to show how differences in rim tape reflectivity affect the color near the edge when used in their normal manner. A Kindle Fire HDX was obtained from Amazon. The “as-received” backlight of the Kindle fire HDX (which contains 3M™ QDEF-210) has white/black tape overlapping the QDEF on the LED side, but has the blue edge defect. To see if ESR could improve on the color uniformity in this case on the LED side, the “as-received” tape was partially removed and replaced with ESR as shown in FIG. 19.

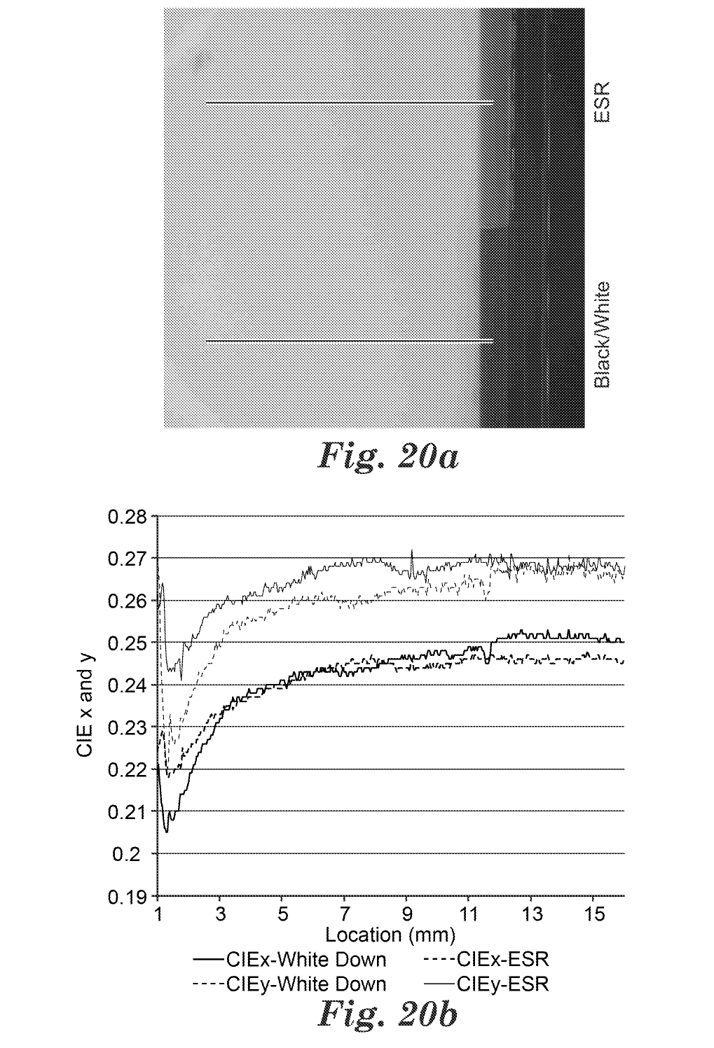

The picture and graph shown in FIGS. 20a and 20b show that when ESR overlaps the QDEF edge by 1.5 mm on the LED edge of the backlight unit, significantly increased CIEx and CIEy values right next to the tape are obtained as compared to the white tape case. Visually, this example showed obvious improvement with respect to blue edge (that is, blue edge was reduced).

Thus, the blue edge defect that is commonly seen in QDEF based displays can be significantly improved by adding highly reflective material around the edge of the QDEF part. The reflectivity and overlap (along with extraction pattern) can be used to fine tune the output color from the display near the edges.

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. An edge-lit LCD backlight unit having a viewable area comprising:
(a) a downconversion film element;
(b) a light guide comprising extraction elements;
(c) a reflector; and
(d) blue LEDs;
wherein the extraction elements extend beyond the viewable area.

2. An LCD backlight unit comprising:
(a) a support structure;
(b) a downconversion film element;
(c) a reflector;
(d) blue LEDs; and
(e) at least one of a highly reflective material and a down converting material;
wherein the highly reflective material or the down converting material overlaps the edges of the downconversion film element or is applied to the support structure.

3. An edge-lit LCD backlight unit having a viewable area comprising:
(a) a support structure;
(b) a downconversion film element;
(c) a light guide comprising extraction elements;
(d) a reflector;
(e) blue LEDs; and
(f) at least one of highly reflective material and a down converting material;
wherein the highly reflective material or the down converting material overlaps the edges of the downconversion film element or is applied to the support structure, and
wherein the extraction elements extend beyond the viewable area.

4. The LCD backlight of claim 1 wherein the downconversion film element is a quantum dot film.

5-11. (canceled)

12. The LCD backlight of claim 2 wherein the downconversion film element is a quantum dot film.

13. The LCD backlight of claim 3 wherein the downconversion film element is a quantum dot film.

14. A method of improving color uniformity across an LCD backlight unit having a viewable area comprising increasing red and green light in at least one edge of the viewable area;
wherein the LCD backlight unit comprises a downconversion film element, a reflector and blue LEDs.

15. The method of claim 14 wherein the LCD backlight is edge-lit and wherein increasing red and green light in at least one edge of the viewable area comprises increasing blue light extraction beyond at least one edge of the viewable area.

16. The method of claim 15 wherein the LCD backlight further comprises a light guide and wherein increasing blue light extraction beyond at least one edge of the viewable area comprises adding extraction features on the light guide beyond at least one edge of the viewable area.

17. The method of claim 14 wherein increasing red and green light in at least one edge of the viewable area comprises reflecting red and green light back into the viewable area.

18. The method of claim 17 wherein increasing red and green light back the viewable area comprises adding a highly reflective material or down converting material to at least one edge of the downconversion film element or to the support structure.

19. The method of claim 17 wherein the LCD backlight unit further comprises a support structure and increasing red and green light back into the viewable area comprises applying a highly reflective material or a down converting material to at least one edge of the downconversion film element.

20. The method of claim 14 wherein the downconversion film element is a quantum dot film.
